(19) United States
(12) Patent Application Publication
(10) Pub. No.: US 2025/0370107 A1
(43) Pub. Date: Dec. 4, 2025

(54) DISTANCE MEASURING DEVICE, DISTANCE MEASURING SYSTEM, AND DISTANCE MEASURING METHOD

(71) Applicant: SONY SEMICONDUCTOR SOLUTIONS CORPORATION, KANAGAWA (JP)

(72) Inventors: Takuya TSURUZONO, KANAGAWA (JP); Ryohei IKENO, KANAGAWA (JP)

(21) Appl. No.: 18/876,757

(22) PCT Filed: Jun. 14, 2023
(86) PCT No.: PCT/JP2023/022012

§ 371 Date: Dec. 19, 2024

(30) Foreign Application Priority Data
Jun. 29, 2022 (JP) 2022-105072

(51) Int. Cl. G01S 7/4915; G01S 7/484; G01S 7/4863; G01S 17/48; G01S 17/89

(52) U.S. Cl. CPC G01S 7/4915; G01S 7/484; G01S 7/4863; G01S 17/48; G01S 17/89

(57) ABSTRACT

The present disclosure provides a light receiving device, a control method, and a distance measuring system capable of suppressing an increase in size of a device that generates a distance measurement value on the basis of a phase difference.

According to the present disclosure, provided is a distance measuring device including: a distance measuring sensor that receives reflected light that is pattern light emitted from a light source device, reflected by an object, and returned; a first distance generation unit that generates a first distance measurement value that is a distance to the object on the basis of a position of the pattern light received by the distance measuring sensor; a phase generation unit that generates, as a phase difference, a time from when the pattern light is emitted to when the pattern light is received as the reflected light; and a second distance generation unit that generates a second distance measurement value that is a distance to the object, according to: the phase difference; and a repetition period of the phase difference based on the first distance measurement value.

### TECHNICAL FIELD

The present disclosure relates to a distance measuring device, a distance measuring system, and a distance measuring method.

### BACKGROUND ART

As a distance measuring method in a distance measuring module, for example, an Indirect Time of Flight (Indirect ToF) scheme is generally known. In the Indirect ToF scheme, a time from when pattern light is emitted toward an object to when the pattern light is received as reflected light is generated as a phase difference, and a distance measurement value is generated on the basis of the phase difference.

### CITATION LIST

### Patent Document

Patent Document 1: Japanese Patent No. 6727539
Patent Document 2: WO 2021/085128 A

### SUMMARY OF THE INVENTION

### Problems to be Solved by the Invention

Since a repetition period of the phase difference occurs, the distance measurement value may be limited within one period. For this reason, a technology is known for obtaining a repetition period by using a distance measurement value by an optical system different from the Indirect ToF scheme. However, since different optical systems are provided, a distance measuring device becomes large.

Thus, the present disclosure provides a light receiving device, a control method, and a distance measuring system capable of suppressing an increase in size of a device that generates a distance measurement value on the basis of a phase difference.

### Solutions to Problems

In order to solve the problem described above, according to the present disclosure,
there is provided a distance measuring device including:
a distance measuring sensor that receives reflected light that is pattern light emitted from a light source device, reflected by an object, and returned;
a first distance generation unit that generates a first distance measurement value that is a distance to the object on the basis of a position of the pattern light received by the distance measuring sensor;
a phase generation unit that generates, as a phase difference, a time from when the pattern light is emitted to when the pattern light is received as the reflected light; and
a second distance generation unit that generates a second distance measurement value that is a distance to the object, according to: the phase difference; and a repetition period of the phase difference based on the first distance measurement value.

There may be further included an output processing unit that generates a third distance measurement value on the basis of the first distance measurement value and the second distance measurement value.

The pattern light may be emitted to the object at a predetermined period, and
the distance measuring sensor may accumulate charges at the predetermined period and at a plurality of different phases.

There may be further included a first image generation unit that generates a two-dimensional first image on the basis of at least one of a plurality of detection signals based on the charges accumulated at the plurality of different phases, and
the first distance generation unit may generate the first distance measurement value by using the first image generated by the first image generation unit.

The first distance generation unit may detect a position of a bright portion of the pattern light, and generate the first distance measurement value by a principle of triangulation on the basis of the position of the bright portion detected.

The plurality of different phases may be four types of a phase of 0 degrees, a phase of 90 degrees, a phase of 180 degrees, and a phase of 270 degrees, and
the first image generation unit may generate the first image on the basis of a combination of the detection signals with the phase of 0 degrees and the phase of 180 degrees or a combination of the detection signals with the phase of 90 degrees and the phase of 270 degrees.

The first image generation unit may generate the first image on the basis of any of the phase of 0 degrees, the phase of 90 degrees, the phase of 180 degrees, and the phase of 270 degrees.

There may be further included a period determination unit that determines a repetition period of the phases on the basis of the first distance measurement value, and
the second distance generation unit may generate the second distance measurement value on the basis of the repetition period.

The output processing unit may generate the third distance measurement value by performing weighted averaging on the first distance measurement value and the second distance measurement value by using a first weight value corresponding to the first distance measurement value and a second weight value corresponding to the second distance measurement value.

There may be further included a determination processing unit that determines whether or not the detection signals in detection of the phase difference are in a saturation state, and
the output processing unit may generate the third distance measurement value in accordance with determination by the determination processing unit.

The first distance generation unit may generate the first distance measurement value by using the first image generated on the basis of the combination of the detection signals with the phase of 0 degrees and the phase of 180 degrees or the combination of the detection signals with the phase of 90 degrees and the phase of 270 degrees in a case where the determination processing unit determines that the detection signals are in the saturation state.

The first distance generation unit may generate the first distance measurement value by using the first image generated on the basis of the detection signals with the phase of 0 degrees, the phase of 90 degrees, the phase of 180 degrees, and the phase of 270 degrees in a case where the determination processing unit determines that the detection signals are not in the saturation state.

There may be further included a second period determination unit that determines a geometric second repetition period of the pattern light on the basis of the second distance measurement value.

The first distance generation unit may generate the first distance measurement value on the basis of the second repetition period.

The first distance generation unit may generate the first distance measurement value on the basis of the second repetition period in a case where the detection signals are determined to be in the saturation state.

In order to solve the problem described above, according to the present disclosure, there may be provided:
a light source device that emits pattern light having two types of luminance of a bright portion and a dark portion; and
a distance measuring device that receives reflected light that is the pattern light reflected by an object and returned, in which
the distance measuring device may include:
a distance measuring sensor that receives the reflected light that is the pattern light emitted from the light source device, reflected by the object, and returned;
a first distance generation unit that generates a first distance measurement value that is a distance to the object on the basis of a position of the pattern light received by the distance measuring sensor;
a phase generation unit that generates, as a phase difference, a time from when the pattern light is emitted to when the pattern light is received as the reflected light; and
a second distance generation unit that generates a second distance measurement value that is a distance to the object, according to: the phase difference; and a repetition period of the phase difference based on the first distance measurement value.

The distance measuring device may further include an output processing unit that generates a third distance measurement value on the basis of the first distance measurement value and the second distance measurement value.

There may be further included a display device that displays a distance image on the basis of the third distance measurement value.

In order to solve the problem described above, according to the present disclosure,
there is provided a distance measuring method using reflected light that is pattern light emitted from a light source device, reflected by an object, and returned, the distance measuring method including:
a first distance generation step of generating a first distance measurement value that is a distance to the object on the basis of a position of the pattern light included in the reflected light;
a phase generation step of generating, as a phase difference, a time from when the pattern light is emitted to when the pattern light is received as the reflected light; and
a second distance generation step of generating a second distance measurement value that is a distance to the object, according to: the phase difference; and a repetition period of the phase difference based on the first distance measurement value.

There may be further included an output processing step of generating a third distance measurement value on the basis of the first distance measurement value and the second distance measurement value.

### BRIEF DESCRIPTION OF DRAWINGS

FIG. 1 is a diagram illustrating a schematic configuration example of a distance measuring system to which the present technology is applied.

FIG. 2 is a block diagram illustrating a configuration example of a light source device and a distance measuring device.

FIG. 3 is a diagram schematically illustrating a relationship between a distance to an object and a distance measurement scheme.

FIG. 4 is a perspective view illustrating a chip configuration example of the distance measuring device.

FIG. 5 is a block diagram illustrating a configuration example of a distance measuring sensor.

FIG. 6 is a block diagram illustrating a configuration example of a pixel.

FIG. 7 is a diagram illustrating a relationship between a light emission pattern of a light emitting source and a detection signal in a pixel.

FIG. 8 is a block diagram illustrating a configuration example of a signal processing unit.

FIG. 9 is a diagram illustrating a relationship between a distance to a target object and a first image and a sixth image.

FIG. 10 is a diagram describing an algorithm example of first distance measurement value generation by a first distance generation unit.

FIG. 11 is a diagram illustrating a phase difference generated by a phase generation unit.

FIG. 12 is a diagram illustrating an example of a second distance measurement value for each frequency.

FIG. 13 is a diagram illustrating a distance measurement value by pulsed light with a period of 120 MHz and the second distance measurement value by pulsed light with a period of 10 MHz that is to be compared.

FIG. 14 is a flowchart illustrating a control example in a distance measuring system 1.

FIG. 15 is a diagram illustrating a relationship between a distance measurement error and a distance, of a distance measurement value obtained by weighted addition and a distance measurement value to which a first distance measurement value is not added.

FIG. 16 is a block diagram illustrating a configuration example of the signal processing unit according to a second embodiment.

FIG. 17 is a diagram schematically illustrating a distance measuring range of pattern light in the first distance generation unit.

### MODE FOR CARRYING OUT THE INVENTION

Hereinafter, embodiments of a distance measuring device, a distance measuring system, and a distance measuring method will be described with reference to the drawings. Hereinafter, main components of the distance measuring device, the distance measuring system, and the distance measuring method will be mainly described, but there may be components and functions that are not illustrated or described in the distance measuring device, the distance measuring system, and the distance measuring method. The following description does not exclude the components and functions that are not illustrated or described.

### First Embodiment

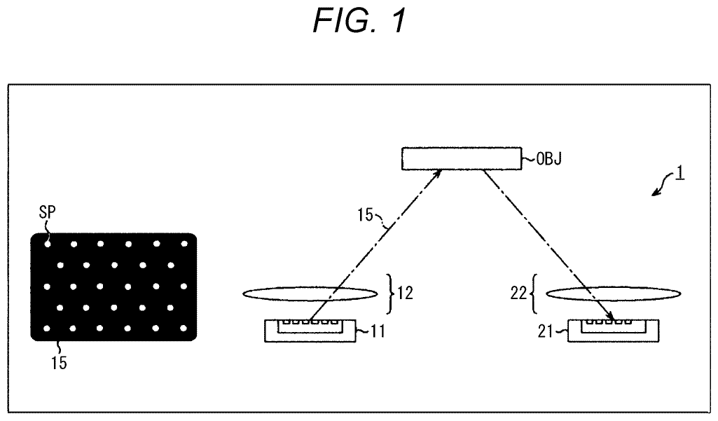

FIG. 1 is a diagram illustrating a schematic configuration example of a distance measuring system to which the present technology is applied. A distance measuring system 1 illustrated in FIG. 1 includes a light source device 11, a light-emitting side optical system 12, a distance measuring device 21, a light-receiving side optical system 22, and a display device 51. The light source device 11 generates and emits pattern light 15 having two types of luminance, for example, a bright portion and a dark portion. The pattern light 15 is, for example, pattern light having a plurality of spots SP having dot (circle) shapes arranged at regular or irregular predetermined intervals as illustrated in FIG. 1, as a bright portion, and a region other than that, as a dark portion. Note that the pattern light 15 emitted by the light source device 11 is not limited to a pattern in which the bright portion has a dot shape, and may be a lattice pattern or the like. The pattern light 15 emitted from the light source device 11 is emitted to a predetermined object OBJ as an object to be measured through the light-emitting side optical system 12. Then, the pattern light 15 is reflected by the predetermined object OBJ and is incident on the distance measuring device 21 through the light-receiving side optical system 22.

The distance measuring device 21 receives the pattern light 15 reflected by the object OBJ and incident. The distance measuring device 21 generates a detection signal corresponding to an amount of light of the pattern light 15 received. Then, the distance measuring device 21 calculates and outputs a distance measurement value that is a measurement value of a distance to the predetermined object OBJ on the basis of the detection signal.

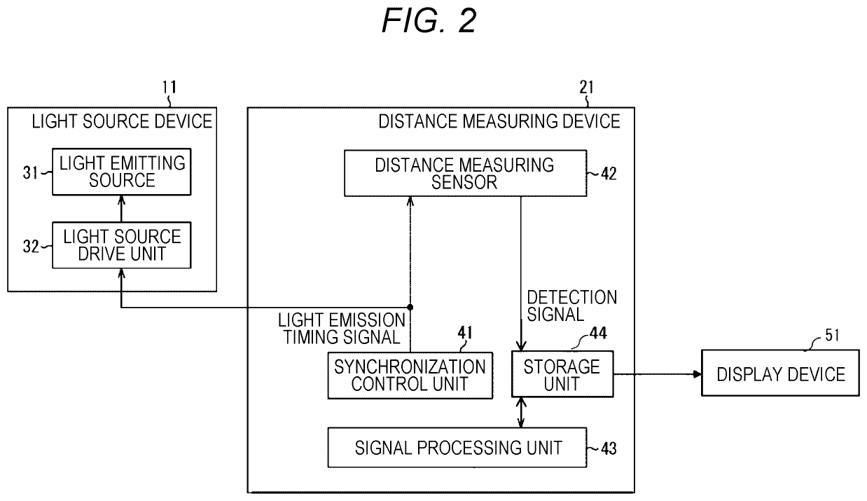

FIG. 2 is a block diagram illustrating a configuration example of the light source device 11 and the distance measuring device 21. As illustrated in FIG. 2, the light source device 11 includes a light emitting source 31 and a light source drive unit 32. The distance measuring device 21 includes a synchronization control unit 41, a distance measuring sensor 42, a signal processing unit 43, and a storage unit 44.

The light emitting source 31 includes, for example, a light source array in which a plurality of light emitting elements such as a vertical cavity surface emitting laser (VCSEL) is arranged in a planar direction. In accordance with control of the light source drive unit 32, the light emitting source 31 emits light while modulating the light at a timing corresponding to a light emission timing signal supplied from the synchronization control unit 41 of the distance measuring device 21, and emits the pattern light 15 as irradiation light to the predetermined object OBJ. As the irradiation light, for example, infrared light having a wavelength in a range of about 850 nm to 940 nm is used.

The light source drive unit 32 includes, for example, a laser driver or the like, and causes each light emitting element of the light emitting source 31 to emit light in accordance with the light emission timing signal supplied from the synchronization control unit 41. The synchronization control unit 41 of the distance measuring device 21 generates the light emission timing signal for controlling a timing at which each light emitting element of the light emitting source 31 emits light, and supplies the light emission timing signal to the light source drive unit 32. Furthermore, the synchronization control unit 41 also supplies the light emission timing signal to the distance measuring sensor 42 in order to drive the distance measuring sensor 42 in accordance with a light emission timing of the light emitting source 31. As the light emission timing signal, for example, a rectangular wave signal (pulse signal) can be used that is turned on and off at a predetermined frequency (for example, 10 MHZ, 20 MHZ, 50 MHZ, 120 MHz, or the like). Note that the light emission timing signal is not limited to the rectangular wave as long as it is a periodic signal, and may be, for example, a sine wave.

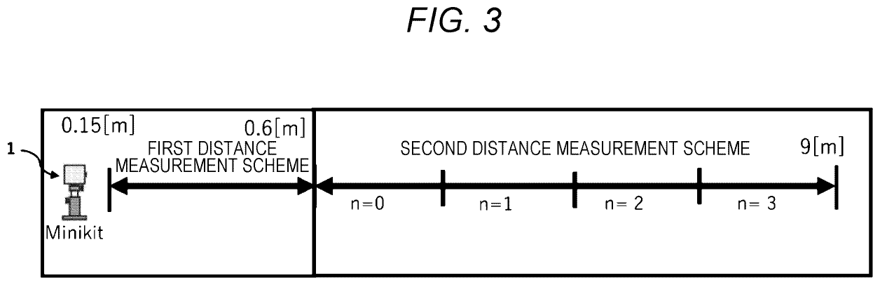

The distance measuring sensor 42 receives reflected light that is the pattern light 15 emitted from the light source device 11 and reflected by the predetermined object OBJ, by a pixel array unit 63 (see FIG. 3) in which a plurality of pixels 71 (see FIG. 3) is two-dimensionally arranged in a matrix. Then, the distance measuring sensor 42 supplies a detection signal corresponding to an amount of received light of the reflected light received, to the signal processing unit 43 in units of pixels of the pixel array unit 63.

The signal processing unit 43 includes, for example, a central processing unit (CPU). The signal processing unit 43 performs signal processing in accordance with a program stored in the storage unit 44. That is, the signal processing unit 43 generates a distance measurement value that is a distance from the distance measuring sensor 42 to the predetermined object OBJ on the basis of the detection signal supplied from the distance measuring sensor 42.

FIG. 3 is a diagram schematically illustrating a relationship between the distance to the object OBJ and a distance measurement scheme. As illustrated in FIG. 3, the signal processing unit 43 according to the present embodiment generates the distance measurement value mainly by a first distance measurement scheme in a range of a first distance, and generates the distance measurement value mainly by a second distance measurement scheme in a range of a second distance that is farther than the range of the first distance, for example.

The first distance measurement scheme generates a first distance measurement value on the basis of, for example, a position of the spot SP of the bright portion in the pattern light on the distance measuring sensor 42. As the first distance measurement scheme, for example, a so-called SL scheme can be used, and the position of the spot SP that is the bright portion of the pattern light 15 is detected, and the first distance measurement value is generated by a principle of triangulation by using the position of the detected spot light. Furthermore, the signal processing unit 43 can selectively use an image to be used in the first distance measurement scheme depending on the distance to the object OBJ.

The second distance measurement scheme is, for example, a time of flight (ToF) scheme, and detects, as a phase difference, a time from when the spot SP that is the bright portion of the pattern light 15 is emitted to when the spot SP is received as reflected light, and calculates the distance on the basis of the phase difference. More specifically, the second distance measurement scheme according to the present embodiment generates a second distance measurement value by using the distance based on the phase difference, and a number of repetition periods n based on the first distance measurement value.

For example, in the range of the first distance, the detection signal may be saturated, and the distance measurement accuracy by the second distance measurement scheme tends to decrease, but the distance measurement accuracy by the first distance measurement scheme is maintained. On the other hand, in the range of the second distance, the distance measurement accuracy by the first distance measurement scheme tends to decrease, but has accuracy enough to determine the number of repetition periods n.

The storage unit 44 is implemented by, for example, a random access memory (RAM), a semiconductor memory element such as a flash memory, a hard disk, an optical disk, or the like. The storage unit 44 stores the detection signal, the first distance measurement value, the second distance measurement value, and the like. The display device 51 is, for example, a monitor. The display device 51 can display, for example, a two-dimensional distance image.

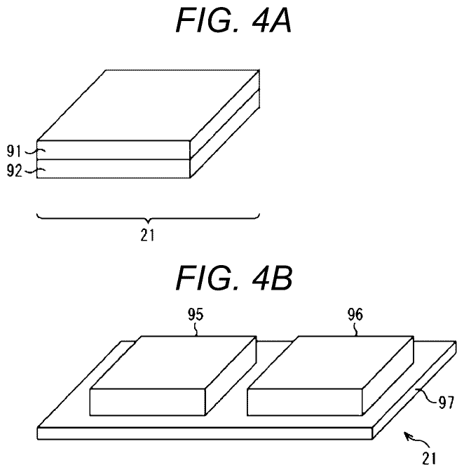

FIG. 4 is a perspective view illustrating a chip configuration example of the distance measuring device 21. As illustrated in A of FIG. 4, the distance measuring device 21 can be configured by one chip in which a first die (substrate) 91 and a second die (substrate) 92 are stacked. The first die 91 includes, for example, the synchronization control unit 41 and the distance measuring sensor 42, and the second die 92 includes, for example, the signal processing unit 43 and the storage unit 44.

Note that the distance measuring device 21 may be configured by three layers obtained by stacking another logic die in addition to the first die 91 and the second die 92, or may be configured by stacking four or more layers of dies (substrates). Furthermore, for example, as illustrated in B of FIG. 4, the distance measuring device 21 can be configured by forming a first chip 95 as the distance measuring sensor 42 and a second chip 96 as the signal processing unit 43 on a relay substrate 97. The synchronization control unit 41 is included in either the first chip 95 or the second chip 96.

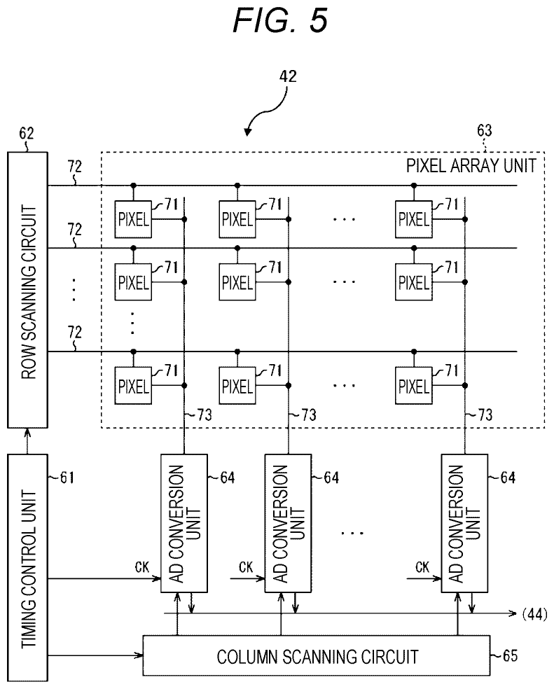

FIG. 5 is a block diagram illustrating a configuration example of the distance measuring sensor 42. The distance measuring sensor 42 includes a timing control unit 61, a row scanning circuit 62, a pixel array unit 63, a plurality of analog to digital (AD) conversion units 64, a column scanning circuit 65, and a signal processing unit 66. In the pixel array unit 63, the plurality of pixels 71 is two-dimensionally arranged in a matrix in the row direction and the column direction. Here, the row direction is the arrangement direction of the pixels 71 in the horizontal direction, and the column direction is the arrangement direction of the pixels 71 in the vertical direction. The row direction is the lateral direction in the figure, and the column direction is the longitudinal direction in the figure.

The timing control unit 61 includes, for example, a timing generator that generates various timing signals and the like, generates various timing signals in synchronization with the light emission timing signal supplied from the synchronization control unit 41 (FIG. 2), and supplies the various timing signals to the row scanning circuit 62, the AD conversion units 64, and the column scanning circuit 65. That is, the timing control unit 61 controls drive timings of the row scanning circuit 62, the AD conversion units 64, and the column scanning circuit 65.

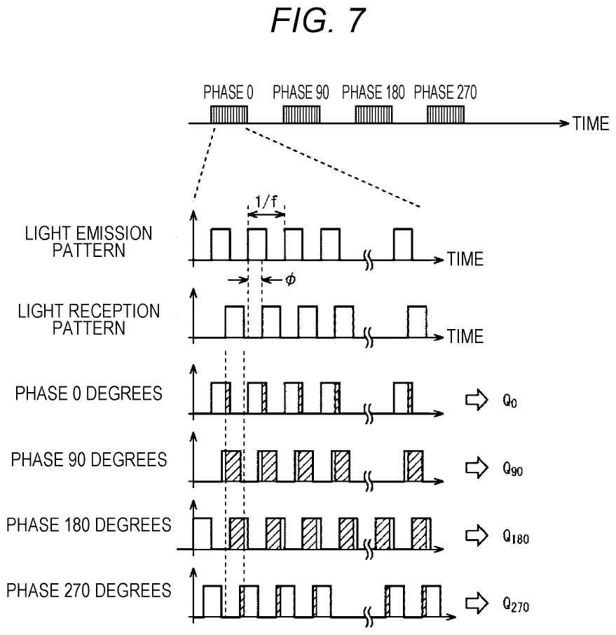

The row scanning circuit 62 includes, for example, a shift register, an address decoder, and the like, and drives the pixels 71 of the pixel array unit 63 at the same time for all pixels or in units of rows. Each pixel 71 receives the reflected light in accordance with control of the row scanning circuit 62 and outputs a detection signal (pixel signal) at a level corresponding to the amount of received light. Details of the pixel 71 will be described later with reference to FIG. 7.

A pixel drive line 72 is wired along the horizontal direction for each pixel row and a vertical signal line 73 is wired along the vertical direction for each pixel column with respect to a matrix-like pixel array of the pixel array unit 63. The pixel drive line 72 transmits a drive signal for driving when the detection signal is read from the pixel 71. In the following description, the pixel 71 may be indicated by a symbol I, and its coordinates may be indicated by (x, y). The coordinate x is a position in the row direction of the pixel I, and the coordinate y is a position in the column direction. In FIG. 5, the pixel drive line 72 is illustrated as one wiring line, but actually includes a plurality of wiring lines. Similarly, the vertical signal line 73 is also illustrated as one wiring line, but actually includes a plurality of wiring lines.

The AD conversion units 64 are provided on a column basis, and perform AD conversion on detection signals supplied, through the vertical signal line 73, from the pixels 71 of the corresponding column in synchronization with a clock signal CK supplied from the timing control unit 61. The AD conversion units 64 output the detection signals (detection data) subjected to AD conversion to the signal processing unit 66 in accordance with control of the column scanning circuit 65. The column scanning circuit 65 sequentially selects the AD conversion units 64 and outputs the detection data after the AD conversion to the signal processing unit 66.

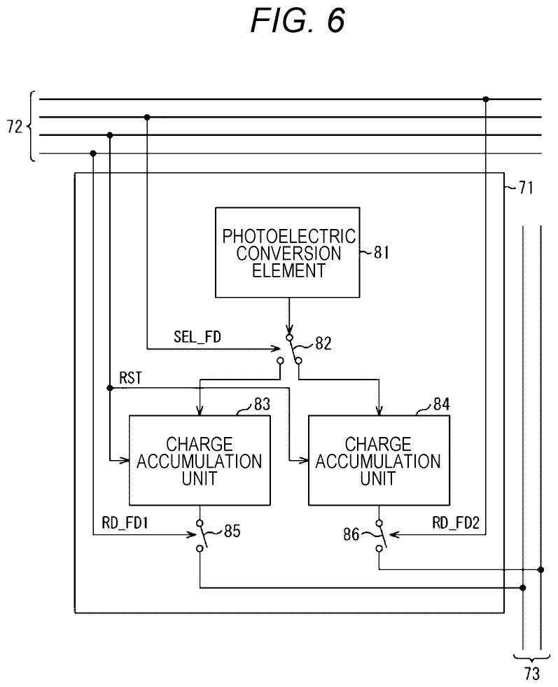

FIG. 6 is a block diagram illustrating a configuration example of the pixel 71. As illustrated in FIG. 6, the pixel 71 includes a photoelectric conversion element 81, a transfer switch 82, charge accumulation units 83 and 84, and selection switches 85 and 86. The photoelectric conversion element 81 includes, for example, a photodiode, and photoelectrically converts the reflected light to generate charges. The transfer switch 82 transfers the charges generated by the photoelectric conversion element 81 to one of the charge accumulation units 83 and 84 on the basis of a transfer signal SEL_FD. The transfer switch 82 includes, for example, a pair of metal-oxide-semiconductor (MOS) transistors.

The charge accumulation units 83 and 84 include, for example, a floating diffusion layer, accumulate charges, and generate voltages according to the accumulated charges. The charges accumulated in the charge accumulation units 83 and 84 can be reset on the basis of a reset signal RST. The selection switch 85 selects an output of the charge accumulation unit 83 in accordance with a selection signal RD_FD1. The selection switch 86 selects an output of the charge accumulation unit 84 in accordance with a selection signal RD_FD2. That is, when the selection switch 85 or 86 is turned on by the selection signal RD_FD1 or RD_FD2, a signal of a voltage corresponding to the accumulated charges of the charge accumulation unit 83 or 84 turned on is output to the AD conversion units 64 through the vertical signal line 73 as a detection signal. Each of the selection switches 85 and 86 includes, for example, a MOS transistor or the like.

A wiring line for transmitting the transfer signal SEL_FD, the reset signal RST, and the selection signals RD_FD1 and RD_FD2 corresponds to the pixel drive line 72 in FIG. 4. When the charge accumulation units 83 and 84 are referred to as a first tap and a second tap, respectively, in the ToF scheme, the pixel 71 can acquire detection signals of two light reception timings whose phases are inverted from each other, for example, a phase of 0 degrees and a phase of 180 degrees, in one frame by alternately accumulating charges generated by the photoelectric conversion element 81 in the first tap and the second tap. In the next frame, detection signals of two light reception timings of a phase of 90 degrees and a phase of 270 degrees can be acquired.

FIG. 7 is a diagram illustrating a relationship between a light emission pattern of the light emitting source 31 and a detection signal in the pixel 71. Illustrated are, from the top, a light emission pattern of the light emitting source 31, a light reception pattern that is a timing at which the light emission pattern is received by the pixel 71, and detection signals of the phase of 0 degrees, the phase of 90 degrees, the phase of 180 degrees, and the phase of 270 degrees. The longitudinal axis of each signal indicates a high level and a low level, and the lateral axis indicates time. The high level of the light emission pattern indicates a time during which the pattern light 15 (see FIG. 1) is emitted, and the high level of the light reception pattern indicates a time during which the pattern light 15 is reflected and returned. That is, in the present embodiment, pulsed light that repeatedly turns on and off at a high speed at a frequency f (modulation frequency) is adopted. One period T of the pulsed light is 1/f. In the pixel 71, the phase of the reflected light (light reception pattern) is detected to be shifted according to a time Δt required for the light to reach the distance measuring sensor 42 from the light emitting source 31.

The high level in the detection signal of the phase of 0 degrees indicates the light reception timing of the pixel 71. That is, it is a timing of the phase of the pulsed light emitted from the light emitting source 31 of the light source device 11, that is, the same phase as the light emission pattern.

Similarly, the high level of the detection signal of the phase of 90 degrees has a timing of a phase delayed by 90 degrees from the pulsed light (light emission pattern) emitted from the light emitting source 31 of the light source device 11. Similarly, the high level of the detection signal of the phase of 180 degrees has a timing of a phase delayed by 180 degrees from the pulsed light (light emission pattern) emitted from the light emitting source 31 of the light source device 11. Similarly, the high level of the detection signal of the phase of 270 degrees has a timing of a phase delayed by 270 degrees from the pulsed light (light emission pattern) emitted from the light emitting source 31 of the light source device 11.

Measurement signals corresponding to charges accumulated when the light reception timings are of the phase of 0 degrees, the phase of 90 degrees, the phase of 180 degrees, and the phase of 270 degrees, are defined as Q0, Q90, Q180, and Q270, respectively. These signals corresponding to the charges are subjected to AD conversion and stored in the storage unit 44 as measurement signals Q0(x, y), Q90(x, y), Q180(x, y), and Q270(x, y) for each pixel I(x, y).

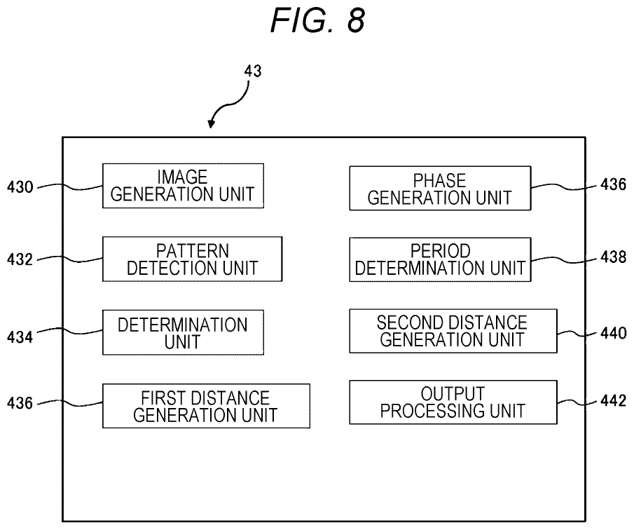

Here, details of the signal processing unit 43 will be described with reference to FIG. 8. FIG. 8 is a block diagram illustrating a configuration example of the signal processing unit 43. As illustrated in FIG. 8, the signal processing unit 43 includes an image generation unit 430, a pattern detection unit 432, a determination unit 434, a first distance generation unit 436, a phase generation unit 437, a period determination unit 438, a second distance generation unit 440, and an output processing unit 442.

The image generation unit 430 generates a two-dimensional image by using at least one of the measurement signals Q0(x, y), Q90(x, y), Q180(x, y), and Q270(x, y). More specifically, the image generation unit 430 adds the measurement signals Q0(x, y), Q90(x, y), Q180(x, y), and Q270(x, y) to generate a pixel value Ga(x, y) of a first image Ga. Furthermore, the image generation unit 430 generates a pixel value G0(x, y) of a second image G0, a pixel value G90(x, y) of a third image G90, a pixel value G180(x, y) of a fourth image G180, and a pixel value G270(x, y) of a fifth image G270 by using the measurement signals Q0(x, y), Q90(x, y), Q180(x, y), and Q270(x, y), respectively. Moreover, the image generation unit 430 generates a pixel value Gb(x, y) of a fifth image Gb obtained by adding the measurement signals Q0(x, y) and Q180(x, y) together, and generates a pixel value Gc(x, y) of a sixth image Gc obtained by adding the measurement signals Q90(x, y) and Q270(x, y) together.

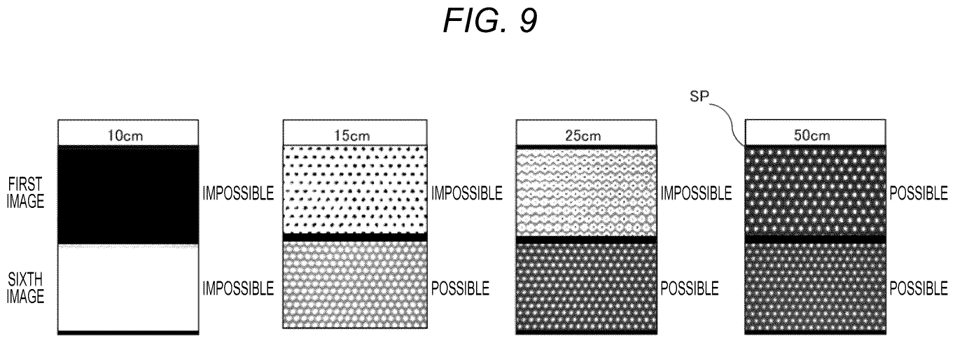

FIG. 9 is a diagram illustrating a relationship between the distance to the target object OBJ and the first image Ga and the sixth image Gc. White indicates a high luminance region, and the upper side indicates the first image Ga and the lower side indicates the sixth image Gc. Examples are illustrated in which the distances to the target object OBJ are 10, 15, 25, and 50 centimeters, for example. As illustrated in FIG. 9, the pixel value Ga(x, y) of the first image Ga is obtained by adding the measurement signals Q0(x, y), Q90(x, y), Q180(x, y), and Q270(x, y) together, and thus an image with a better SN ratio is generated. On the other hand, for example, at a short distance of about 25 cm, the pixels are saturated, and there is a possibility that it becomes impossible to individually determine a region of the spot SP of the bright portion. In contrast to this, as illustrated in FIG. 9, in the sixth image Gc, it is possible to individually determine the region of the spot SP of the bright portion up to about 15 cm.

Furthermore, magnitudes of respective signal values of the measurement signals Q0(x, y), Q90(x, y), Q180(x, y), and Q270(x, y) are different from each other. For this reason, the contrast of the region of the spot SP of the bright portion in the pattern light differs. As a result, in any of the second image G0, the third image G90, the fourth image G180, and the fifth image G270, for example, even when the distance to the target object OBJ is about 15 cm, the region of the spot SP of the bright portion can be more clearly determined.

The pattern detection unit 432 detects, for example, a region of the spot SP of the bright portion in the pattern light from the two-dimensional image generated by the image generation unit 430. The pattern detection unit 432 performs, for example, binarization processing on the two-dimensional image, and then performs labeling processing. Then, the pattern detection unit 432 stores information on the region subjected to the labeling processing and coordinates corresponding to the barycentric positions of respective regions subjected to the labeling processing in the storage unit 44.

The determination unit 434 determines whether or not there is a saturated region in the two-dimensional image from the information on the region where the pattern detection unit 432 has performed the labeling processing on the first image Ga. For example, in a case where it is determined that the size of each region subjected to the labeling processing exceeds a predetermined range, saturation is determined. As a result, a determination result for each pixel I(x, y) is stored in the storage unit 44. For example, the determination unit 434 stores 0 in association with the pixel I(x, y) in a non-saturated region, and stores 1 in association with the pixel I(x, y) in a saturated region.

The first distance generation unit 436 generates a first distance measurement value D1(x, y) for each pixel I(x, y) by the above-described first distance measurement scheme. The first distance generation unit 436 can vary an image to be used for generating the first distance measurement value according to the determination result by the determination unit 434. For example, the first distance generation unit 436 generates the first distance measurement value by using the first image Ga for a region determined, by the determination unit 434, to be not saturated. In this case, for example, the object OBJ is at a distance greater than or equal to 60 cm, and measurement accuracy is improved by using a signal with a higher SN. On the other hand, the first distance generation unit 436 generates the first distance measurement value by using the fifth image Gb or the sixth image Gc for a region determined, by the determination unit 434, to be saturated. In this case, by using the fifth image Gb or the sixth image G whose saturation is suppressed more than the first image Ga, it is possible to improve the measurement accuracy with respect to the object OBJ at a shorter distance.

Furthermore, the first distance generation unit 436 may select an image in any of the second image G0, the third image G90), the fourth image G180, and the fifth image G270, and generate the first distance measurement value. In this case, the first distance generation unit 436 selects an image having the smallest size of each region subjected to the labeling processing by the determination unit 434. In this case, by using any of the second image G0, the third image G90, the fourth image G180, and the fifth image G270, in which the saturation is further suppressed than the fifth image Gb or the sixth image Gc, it is possible to further improve the measurement accuracy with respect to the object OBJ at a short distance.

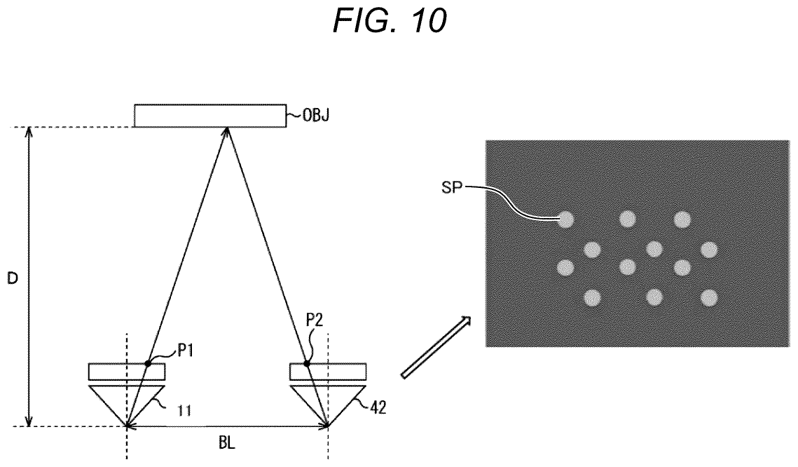

FIG. 10 is a diagram describing an algorithm example of first distance measurement value generation by the first distance generation unit 436. As illustrated in FIG. 10, this is an example of a case where the SL scheme is used for the first distance generation unit 436. In the SL scheme, the light source device 11 that projects pattern light and the distance measuring sensor 42 that receives the pattern light are used to search for a pair of a certain position in the projected pattern and a position of a corresponding light receiving sensor, whereby distance measurement is performed with application of triangulation.

It is assumed that the light source device 11 emits the plurality of spots SP arranged at predetermined intervals to the object OBJ as illustrated in FIG. 1, attention is paid on one spot SP (Hereinafter, it is referred to as an attention spot SP.), and the attention spot SP is detected at a predetermined position P2 of a light receiving region of the distance measuring sensor 42. The pattern detection unit 432 stores each of the barycentric coordinates of the position P2 in the storage unit 44.

At this time, a position P1 in the projected pattern of the light source device 11 that has emitted the attention spot SP is known in the light source device 11. Furthermore, a positional relationship is also known between the light source device 11 and the distance measuring sensor 42 including a baseline distance BL between a light source principal point (projection center) of the light source device 11 and a sensor principal point (light reception center) of the distance measuring sensor 42. Thus, the first distance generation unit 436 can calculate the first distance measurement value D1(x, y) corresponding to the distance from the distance measuring device 21 to the object OBJ by the principle of triangulation by using the position P1, the position P2, and the baseline distance BL.

As described above, when the distance measuring sensor 42 receives the plurality of spots SP of the pattern light 15, if it is known which spot SP of the plurality of spots SP emitted by the light source device 11 each of the received spots SP corresponds to, the first distance generation unit 436 can calculate the first distance measurement value D1(x, y) from the distance measuring device 21 to the object OBJ for each pixel I(x, y) for each of the plurality of spots SP.

Thus, the pattern light 15 emitted by the light source device 11 of the distance measuring system 1 is a pattern in which the plurality of spots SP is arranged so that, when the distance measuring sensor 42 receives a predetermined spot SP at a predetermined position in the light receiving region, it is possible to specify (a position of) a spot SP of the light emitting source 31 that has emitted the predetermined spot SP.

Specifically, the position of the spot SP received as reflected light by the distance measuring sensor 42 moves along a predetermined locus in the light receiving region according to the distance to the object OBJ, but if the locus of each spot SP does not overlap with the locus of another spot SP, on the basis of the position of the spot SP received by the distance measuring sensor 42, it is possible to identify (the position of) the spot SP of the light emitting source 31 that has emitted the spot SP. In other words, the pattern light 15 is a dot pattern in which the plurality of spots SP is arranged at sufficiently sparse intervals such that the positions of the spots SP detected by the distance measuring sensor 42 do not overlap with other spots SP.

Here, the phase generation unit 437, the period determination unit 438, and the second distance generation unit 440 will be described with reference to FIG. 7. First, a method for distance measurement by the ToF scheme will be described.

A second distance measurement value D2(x, y) [mm] corresponding to the distance from the distance measuring device 21 to the object OBJ can be calculated by Expression (1) below.

$$\begin{matrix}[ Math . 1 ] & \\ D 2 ( x , y ) = 1 / ( 2 c \times Δ t ( x , y ) ) & ( 1 )\end{matrix}$$

In Expression (1), Δt(x, y) is a time until the pattern light 15 emitted from the light emitting source 31 is reflected by the object OBJ and enters each pixel (x, y) of the distance measuring sensor 42, and c represents the speed of light. The coordinates of the pixel 71 are represented by (x, y).

For the pattern light 15 emitted from the light emitting source 31, pulsed light is adopted that repeatedly turns on and off at a high speed at a predetermined frequency f (modulation frequency) as illustrated in FIG. 7. One period T of the pulsed light is 1/f. In the distance measuring sensor 42, the phase of the reflected light (light reception pattern) is detected to be shifted according to the time Δt(x, y) required for the light to reach the distance measuring sensor 42 from the light emitting source 31. When an amount of shift of the phase (phase difference) between the light emission pattern and the light reception pattern is φ(x, y), the time Δt(x, y) can be calculated by Expression (2) below.

$$\begin{matrix}[ Math . 2 ] & \\ Δ t ( x , y ) = ϕ ( x , y ) / 2 π f & ( 2 )\end{matrix}$$

Thus, a distance measurement value D2a(x, y) from the distance measuring sensor 42 to the object OBJ can be calculated by Expression (3) below from Expressions (1) and (2).

$$\begin{matrix}[ Math . 3 ] & \\ D 2 a ( x , y ) = ( c \times ϕ ( x , y ) ) / 4 π f & ( 3 )\end{matrix}$$

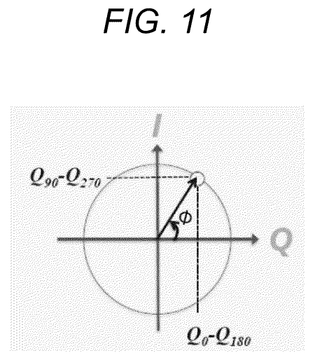

FIG. 11 is a diagram illustrating a phase difference φ generated by the phase generation unit 437. As illustrated in FIG. 11, the phase generation unit 437 calculates the phase difference φ(x, y) of the pixel I(x, y) by Expression (4) below by using the measurement signals Q0(x, y), Q90(x, y), Q180(x, y), and Q270(x, y).

$$\begin{matrix}[ Math . 4 ] & \\ ϕ ( x , y ) = Arc tan ( Q 90 ( x , y ) - Q 270 ( x , y ) ) / ( Q 180 ( x , y ) - Q 0 ( x , y ) ) & ( 4 )\end{matrix}$$

By inputting the phase difference p(x, y) calculated by Expression (4) to Expression (3) described above, it is possible to calculate a second distance measurement value D2a(x, y) from the distance measuring system 1 to the object OBJ.

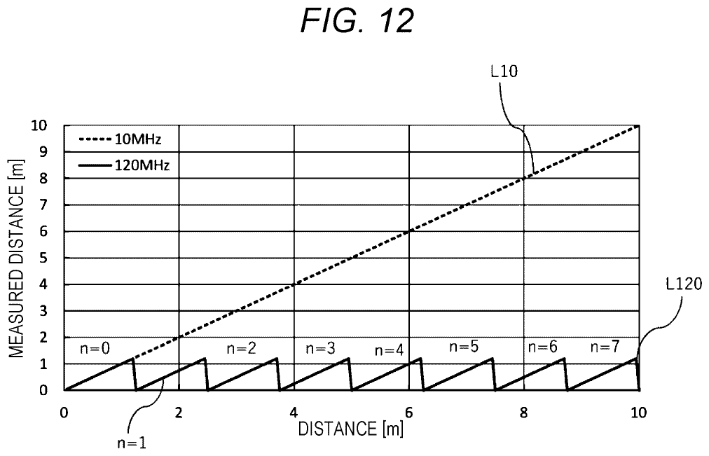

FIG. 12 is a diagram illustrating an example of the second distance measurement value for each frequency. The longitudinal axis represents a measured distance and corresponds to the second distance measurement value. Illustrated are a second distance measurement value L10 in a case where a pulse signal with a frequency of 10 MHz is used for light emission, and a second distance measurement value L120 in a case where a pulse signal with a frequency of 120 MHz is used for light emission.

It is known that the second distance measurement value becomes more accurate as the frequency becomes higher. On the other hand, as indicated by the second distance measurement value L120, a so-called aliasing occurs at a high frequency. For example, the second distance measurement value in a case where the pulse signal with the frequency of 120 MHz is used for light emission is 0 to 1.25 mates. For this reason, the second distance measurement value L120 repeats distance measurement values from 0 to 1.25 mates. The second distance measurement value D2(x, y) in this case is, for example, 0 to 1.25 mates in the case of a repetition period n=0, 1.25 to 2.5 mates in the case of a repetition period n=1, and 7.5 to 8.75 mates in the case of a repetition period n=7.

Thus, the period determination unit 438 determines the repetition period n(x, y) by using the first distance measurement value D1(x, y). That is, the period determination unit 438 divides the first distance measurement value D1(x, y) by D3(f) and makes the result an integer by a floor function floor. D3(f) is a distance determined by the period f of the pulse signal.

$$\begin{matrix}[ Math . 5 ] & \\ n ( x , y ) = floor ( D 1 ( x , y ) / D 3 ( f ) ) & ( 5 )\end{matrix}$$

The second distance generation unit 440 generates the second distance measurement value by the second distance measurement scheme. That is, as indicated in Expression (6), the second distance generation unit 440 generates the second distance measurement value D2(x, y) by using the distance measurement value D2a(x, y) based on the phase difference φ(x, y) and the number of repetition periods n(x, y) based on the first distance measurement value D1(x, y).

$$\begin{matrix}[ Math . 6 ] & \\ D 2 ( x , y ) = D 2 a ( x , y ) + n ( x , y ) \times D 3 ( f ) & ( 6 )\end{matrix}$$

The output processing unit 442 generates a distance measurement value Dall(x, y) corresponding to each pixel I(x, y) by using the first distance measurement value D1(x, y) and the second distance measurement value D2(x, y). More specifically, the determination result by the determination unit 434 about each pixel I(x, y) stored in the storage unit 44 to generate the distance value Dall(x, y). For example, in a case where the determination result about the pixel I(x, y) indicates saturation, the first distance measurement value D1(x, y) is set as the distance value Dall(x, y), and in a case where the determination result does not indicate saturation, the second distance measurement value D2(x, y) is set as the distance measurement value Dall(x, y). The output processing unit 442 may store the distance measurement value Dall(x, y) in the storage unit 44, and may display a generated two-dimensional distance image Dall on the display device 51. As a result, an operator can visually confirm the two-dimensional distance image Dall.

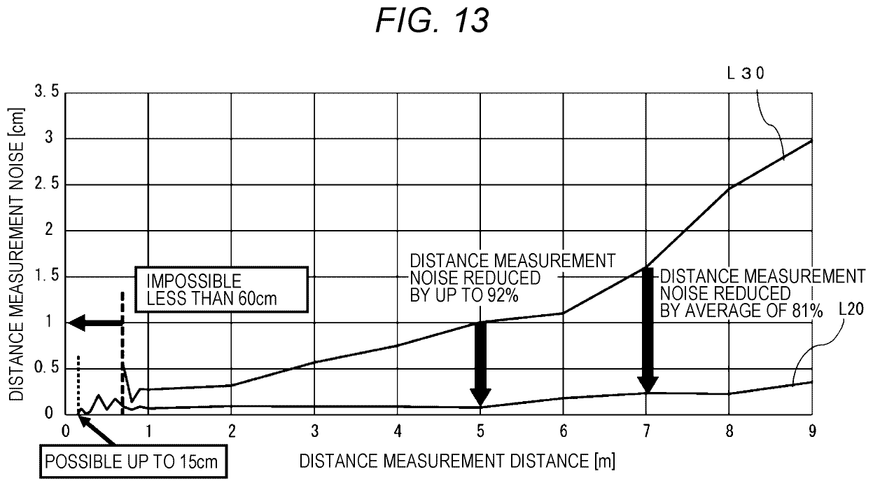

FIG. 13 is a diagram illustrating the distance measurement value Dall(x, y) by pulsed light with a period of 120 MHz and the second distance measurement value D2(x, y) by pulsed light with a period of 10 MHz that is to be compared. The distance measurement value Dall(x, y) by the pulsed light with the period of 120 MHz is indicated by a line L20, and the second distance measurement value D2(x, y) by the pulsed light with the period of 10 MHz is indicated by a line L30. The lateral axis represents the distance to the object OBJ, and the longitudinal axis represents distance measurement noise. The distance measurement noise is a variance of measurement distances.

As illustrated in FIG. 13, only with the second distance measurement value D2(x, y), the measurement signal is saturated, and thus it is difficult to measure, for example, a distance less than 60 centimeters corresponding to the first distance range (see FIG. 3). On the other hand, since the two-dimensional image is used for the first distance measurement value D1(x, y), the position of the spot SP can be detected even when the measurement signal is saturated. For this reason, with the distance measurement value Dall(x, y) according to the present embodiment that also uses the first distance measurement value D1(x, y), it is possible to perform distance measurement up to about 15 centimeters.

Furthermore, conventionally, the distance measurement value by the pulsed light with the period of 120 MHz is 1.25 meters, but with the distance measurement value Dall(x, y) according to the present embodiment, the distance measurement can be performed up to about 9 meters by using information of the number of repetition periods n(x, y). As described above, the second distance measurement value is measured with higher accuracy as the period of the pulsed light is a higher frequency. For this reason, with the distance measurement value Dall(x, y) according to the present embodiment, the distance measurement noise is reduced by 91 percent at 5 meters and reduced by 81 percent at 7 meters as compared with the second distance measurement value D2(x, y) by the pulsed light with the period of 10 MHz that is to be compared.

As described above, the first distance measurement value D1(x, y) can be used as the distance measurement value Dall (x, y) according to the present embodiment. For this reason, it is possible to obtain the distance measurement value Dall(x, y) corresponding to the first distance range (see FIG. 3) in which it is normally difficult to obtain the second distance measurement value D2(x, y) by the Tof method due to saturation of the detection signal.

Furthermore, in a case where distance measurement is performed with the pulsed light with the period of 120 MHZ, even in a case where so-called aliasing occurs in a range greater than or equal to 1.25 meters corresponding to the second distance range (see FIG. 3), the number of periods n(x, y) can be generated with use of the first distance measurement value D1(x, y), and the second distance measurement value D2(x, y) with higher measurement accuracy than the first distance measurement value D1(x, y) can be generated. Furthermore, since the same distance measuring sensor 42 is used, it is possible to prevent a plurality of measurement systems from being provided, and it is possible to suppress an increase in size of the device.

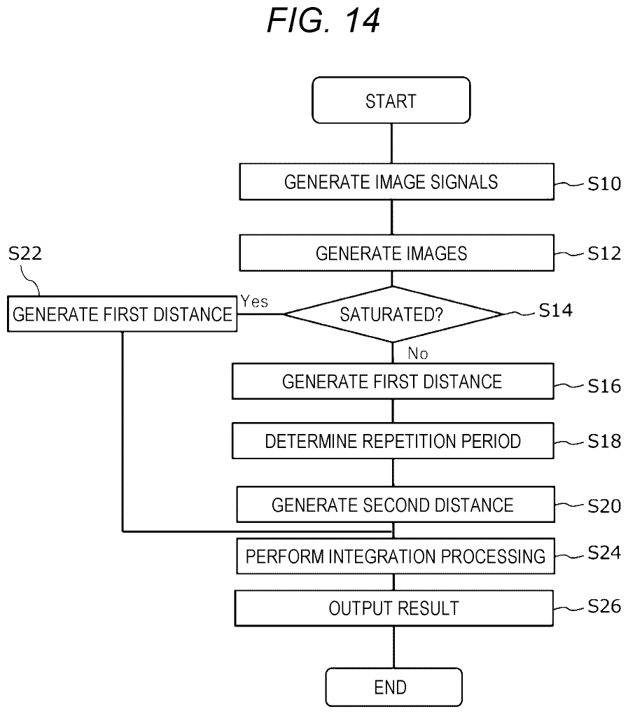

Although the configuration of the distance measuring system 1 according to the present embodiment has been described above, a control example will be described below. FIG. 14 is a flowchart illustrating a control example in the distance measuring system 1. First, the distance measuring sensor 42 of the distance measuring device 21 generates measurement signals Q0(x, y), Q90(x, y), Q180(x, y), and Q270(x, y) (step S10). Next, the image generation unit 430 generates the first image Ga obtained by adding the measurement signals Q0(x, y), Q90(x, y), Q180(x, y), and Q270(x, y) together, and the sixth image Gc obtained by adding the signals SQ90(x, y) and Q270(x, y) together (step S12).

Next, the determination unit 434 determines a saturated region and a non-saturated region of the first image Ga from information on a region where the pattern detection unit 432 has performed the labeling processing on the first image Ga(step S14). In a case where there is a region determined not to be saturated (No in step S14), the first distance generation unit 436 generates the first distance measurement value D1(x, y) for each pixel I(x, y) by using the first image Ga with respect to the non-saturated region (step S16). The determination unit 434 stores, for example, 1 in the storage unit 44 in association with each pixel I(x, y) in the region determined not to be saturated.

Next, the period determination unit 438 determines the repetition period n(x, y) for the region determined not to be saturated by using the first distance measurement value D1(x, y) (step S18). Then, for the region determined not to be saturated, the second distance generation unit 440 generates the second distance measurement value D2(x, y) by using the distance measurement value D2a(x, y) based on the phase difference φ(x, y) generated by the phase generation unit 437 and the number of repetition periods n(x, y) based on the first distance measurement value D1(x, y) (step S20).

On the other hand, in a case where the determination unit 434 determines that there is a saturated region in the first image Ga(x, y) (Yes in step S14), the first distance generation unit 436 generates the first distance measurement value D1(x, y) for each pixel I(x, y) by using the sixth image Gc with respect to the saturated region (step S22). The determination unit 434 stores, for example, 0 in the storage unit 44 in association with each pixel I(x, y) in the region determined to be saturated.

Next, using the determination result by the determination unit 434 for each pixel I(x, y) stored in the storage unit 44, the output processing unit 442 sets the first distance measurement value D1(x, y) as the distance measurement value Dall(x, y) in a case where the determination result for the pixel I(x, y) indicates saturation, and sets the first distance measurement value D2(x, y) as the distance measurement value Dall(x, y) in a case where the determination result does not indicate saturation, to generate the two-dimensional distance image Dall (step S24). Then, the output processing unit 442 stores the two-dimensional distance image Dall in the storage unit 44 and displays the two-dimensional distance image Dall on the display device 51 (step S26).

As described above, according to the present embodiment, the first distance generation unit 436 generates the first distance measurement value D1(x, y) that is the distance to the object OBJ on the basis of the position of the pattern light received by the distance measuring sensor 42, and the second distance generation unit 440 generates the second distance measurement value D2(x, y) by using the distance measurement value D2a(x, y) based on the phase difference q(x, y) generated by the phase generation unit 437 and the number of repetition periods n(x, y) based on the first distance measurement value D1(x, y). As a result, even in a case where aliasing occurs in the phase difference φ(x, y), the second distance measurement value D2(x, y) can be generated with higher accuracy. In this case, since the single distance measuring sensor 42 generates signals used for measurement by the first distance generation unit 436 and the second distance generation unit 440, the distance measuring device 21 can be further downsized.

### Modification 1 of First Embodiment

The distance measuring system 1 according to Modification 1 of the first embodiment is different from the distance measuring system 1 according to the first embodiment in that the output processing unit 442 generates the distance measurement value Dall(x, y) by performing weighted addition of the first distance measurement value D1(x, y) and the second distance measurement value D2a(x, y) to a region determined, by the period determination unit 438, to be not saturated. Hereinafter, differences from the distance measuring system 1 according to the first embodiment will be described.

In accordance with an expression of the output processing unit (7) according to Modification 1 of the first embodiment, weighted addition is performed of the first distance measurement value D1(x, y) and the second distance measurement value D2a(x, y), to generate the distance measurement value Dall(x, y). Here, W_{_ToF}(x, y) is a weight value according to the distance of the second distance measurement value D2a(x, y) and is a reciprocal of a distance variance value σ²_{_ToF}(x, y) according to the distance, as indicated in Expression (8). On the other hand, W_{_SL}(x, y) is a weight value according to the distance of the first distance measurement value D1(x, y) and is a reciprocal of a distance variance value σ^{2_SL}(x, y) according to the distance, as indicated Expression (9).

$$\begin{matrix}[ Math . 7 ] & \\ D all ( x , y ) = \frac{{W}_{SL} ( x , y ) D 2 a ( x , y ) + {W}_{ToF} ( x , y ) D 1 ( x , y )}{{W}_{SL} ( x , y ) + {W}_{ToF} ( x , y )} & ( 7 )\end{matrix}$$

$$\begin{matrix}[ Math . 8 ] & \\ {W}_{ToF} ( x , y ) = \frac{1}{{σ}_{ToF}^{2} ( x , y )} & ( 8 )\end{matrix}$$

$$\begin{matrix}[ Math . 9 ] & \\ {W}_{SL} ( x , y ) = \frac{1}{{σ}_{SL}^{2} ( x , y )} & ( 9 )\end{matrix}$$

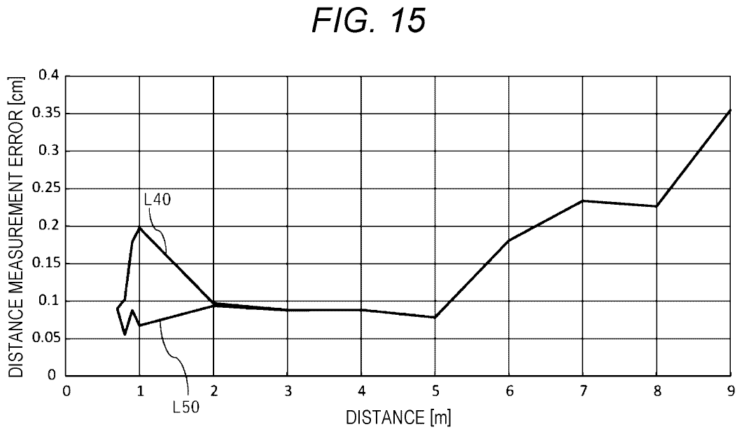

FIG. 15 is a diagram illustrating a relationship between a distance measurement error and a distance, of the distance measurement value Dall(x, y) obtained by weighted addition and the distance measurement value Dall(x, y) to which the first distance measurement value D1(x, y) is not added. A line L40 is the distance measurement value Dall(x, y) to which the first distance measurement value D1(x, y) is not added, and a line L50 is a distance measurement value Dall(x, y) obtained by weighted addition of the first distance measurement value D1(x, y). In the distance measurement value Dall(x, y) obtained by weighted addition, the distance measurement error is improved in a range of 0.9 meters to 2 meters, for example. This is because, for example, in the range of 0.9 meters to 2 meters, since the distance measurement accuracy of the first distance measurement value D1(x, y) is equivalent to the measurement accuracy of the second distance measurement value D2a(x, y), it is considered that the measurement accuracy is improved by addition processing. On the other hand, for example, in a range exceeding 2 meters, the variance value σ^{2_SL}(x, y) increases and the weight value W_{_SL}(x, y) of the first distance measurement value D1(x, y) decreases, so that influence of the first distance measurement value D1(x, y) is reduced. For this reason, the line L40 and the line L50 indicate equivalent values.

As described above, the first distance measurement value D1(x, y) and the second distance measurement value D2a(x, y) are added together with use of the reciprocals of the distance variance values σ²_{_ToF}(x, Y) and σ²_{_SL}(x, y) according to the distance, whereby the measurement accuracy can be further improved.

### Second Embodiment

The distance measuring system 1 according to a second embodiment is different from the distance measuring system 1 according to Modification 1 of the first embodiment in that the first distance generation unit 436 can use information of a repetition period of the pattern light 15 when generating the first distance measurement value D1(x, y). Hereinafter, differences from the distance measuring system 1 according to Modification 1 of the first embodiment will be described.

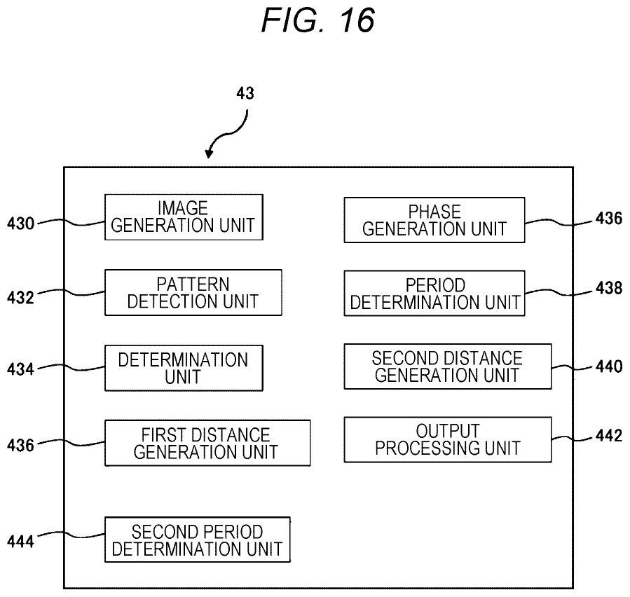

FIG. 16 is a block diagram illustrating a configuration example of the signal processing unit 43 according to the second embodiment. As illustrated in FIG. 16, a second period determination unit 444 is further included.

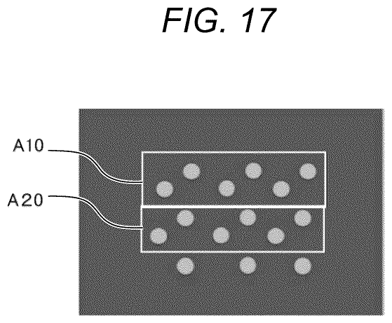

FIG. 17 is a diagram schematically illustrating a distance measuring range of the pattern light 15 in the first distance generation unit 436. For example, the first distance generation unit 436 generates one distance measurement value D1(x, y) according to a position of each spot light of a region A20 on a light receiving surface of the distance measuring sensor 42. In this case, pattern light 15 may include a uniform pattern. In this case, for example, a pattern in a region A10 enters the region A20 as the object OBJ approaches. On the other hand, in a peripheral portion of the distance measuring sensor 42, the second distance generation unit 440 can generate the second distance measurement value D2a(x, y) although the measurement accuracy decreases.

Furthermore, since the pattern light 15 is known, it is possible to determine whether the pattern in the region A10 is a pattern that has been in the region A20 according to the distance to the object OBJ. Thus, with respect to a region where the determination unit 434 determines saturation, the second period determination unit 444 determines a geometric period of the pattern light 15 by using the second distance measurement value D2a(x, y) in the peripheral portion of the distance measuring sensor 42. For example, when the second distance measurement value D2a(x, y) is in a range of 0.6 meters to 0.4 meters, the geometric period is set to m=0, and when the second distance measurement value D2a is in a range of 0.4 meters to 0.15 meters, the geometric period is set to m=1.

In the case of the geometric period m=0, the first distance generation unit 436 generates the first distance measurement value D1(x, y) by using a position detected by the pattern detection unit 432. On the other hand, in the case of the geometric period m=1, the first distance generation unit 436 generates the first distance measurement value D1(x, y) by using a position obtained by adding a predetermined distance D3 to the position detected by the pattern detection unit 432.

As described above, with respect to the region where the determination unit 434 determines saturation, the second period determination unit 444 determines the geometric period of the pattern light 15 by using the second distance measurement value D2a(x, y) in the peripheral portion in the distance measuring sensor 42. As a result, even in a case where the pattern light 15 includes a geometrically uniform repetitive periodic pattern, it is possible to suppress a decrease in the measurement accuracy of the first distance measurement value D1(x, y).

Note that the present technology can have the following configurations.

(1)

A distance measuring device including:
a distance measuring sensor that receives reflected light that is pattern light emitted from a light source device, reflected by an object, and returned;
a first distance generation unit that generates a first distance measurement value that is a distance to the object on the basis of a position of the pattern light received by the distance measuring sensor;
a phase generation unit that generates, as a phase difference, a time from when the pattern light is emitted to when the pattern light is received as the reflected light; and
a second distance generation unit that generates a second distance measurement value that is a distance to the object, according to: the phase difference; and a repetition period of the phase difference based on the first distance measurement value.
   (2)

The distance measuring device according to (1), further including an output processing unit that generates a third distance measurement value on the basis of the first distance measurement value and the second distance measurement value.

(3)

The distance measuring device according to (2), in which
the pattern light is emitted to the object at a predetermined period, and
the distance measuring sensor accumulates charges at the predetermined period and at a plurality of different phases.
   (4)

The distance measuring device according to (3), further including
a first image generation unit that generates a two-dimensional first image on the basis of at least one of a plurality of detection signals based on the charges accumulated at the plurality of different phases, in which
the first distance generation unit generates the first distance measurement value by using the first image generated by the first image generation unit.
   (5)

The distance measuring device according to (4), in which the first distance generation unit detects a position of a bright portion of the pattern light, and generates the first distance measurement value by a principle of triangulation on the basis of the position of the bright portion detected.

(6)

The distance measuring device according to (5), in which
the plurality of different phases is four types of a phase of 0 degrees, a phase of 90 degrees, a phase of 180 degrees, and a phase of 270 degrees, and
the first image generation unit generates the first image on the basis of a combination of the detection signals with the phase of 0 degrees and the phase of 180 degrees or a combination of the detection signals with the phase of 90 degrees and the phase of 270 degrees.
   (7)

The distance measuring device according to (6), in which the first image generation unit generates the first image on the basis of any of the phase of 0 degrees, the phase of 90 degrees, the phase of 180 degrees, and the phase of 270 degrees.

(8)

The distance measuring device according to (7), further including
a period determination unit that determines a repetition period of the phases on the basis of the first distance measurement value, in which
the second distance generation unit generates the second distance measurement value on the basis of the repetition period.
   (9)

The distance measuring device according to (8), in which the output processing unit generates the third distance measurement value by performing weighted averaging on the first distance measurement value and the second distance measurement value by using a first weight value corresponding to the first distance measurement value and a second weight value corresponding to the second distance measurement value.

(10)

The distance measuring device according to (9), further including
a determination processing unit that determines whether or not the detection signals in detection of the phase difference are in a saturation state, in which
the output processing unit generates the third distance measurement value in accordance with determination by the determination processing unit.
   (11)

The distance measuring device according to (10), in which the first distance generation unit generates the first distance measurement value by using the first image generated on the basis of the combination of the detection signals with the phase of 0 degrees and the phase of 180 degrees or the combination of the detection signals with the phase of 90 degrees and the phase of 270 degrees in a case where the determination processing unit determines that the detection signals are in the saturation state.

(12)

The distance measuring device according to (11), in which the first distance generation unit generates the first distance measurement value by using the first image generated on the basis of the detection signals with the phase of 0 degrees, the phase of 90 degrees, the phase of 180 degrees, and the phase of 270 degrees in a case where the determination processing unit determines that the detection signals are not in the saturation state.

(13)

The distance measuring device according to (12), further including a second period determination unit that determines a geometric second repetition period of the pattern light on the basis of the second distance measurement value.

(14)

The distance measuring device according to (13), in which the first distance generation unit generates the first distance measurement value on the basis of the second repetition period.

(15)

The distance measuring device according to (14), in which the first distance generation unit generates the first distance measurement value on the basis of the second repetition period in a case where the detection signals are determined to be in the saturation state.

(16)

A distance measuring system including:
a light source device that emits pattern light having two types of luminance of a bright portion and a dark portion; and
a distance measuring device that receives reflected light that is the pattern light reflected by an object and returned, in which
the distance measuring device includes:
a distance measuring sensor that receives the reflected light that is the pattern light emitted from the light source device, reflected by the object, and returned;
a first distance generation unit that generates a first distance measurement value that is a distance to the object on the basis of a position of the pattern light received by the distance measuring sensor;
a phase generation unit that generates, as a phase difference, a time from when the pattern light is emitted to when the pattern light is received as the reflected light; and
a second distance generation unit that generates a second distance measurement value that is a distance to the object, according to: the phase difference; and a repetition period of the phase difference based on the first distance measurement value.
   (17)

The distance measuring system according to (16), in which the distance measuring device further includes an output processing unit that generates a third distance measurement value on the basis of the first distance measurement value and the second distance measurement value.

(18)

The distance measuring system according to (17), further including a display device that displays a distance image on the basis of the third distance measurement value.

(19)

A distance measuring method using reflected light that is pattern light emitted from a light source device, reflected by an object, and returned, the distance measuring method including:
a first distance generation step of generating a first distance measurement value that is a distance to the object on the basis of a position of the pattern light included in the reflected light;
a phase generation step of generating, as a phase difference, a time from when the pattern light is emitted to when the pattern light is received as the reflected light; and
a second distance generation step of generating a second distance measurement value that is a distance to the object, according to: the phase difference; and a repetition period of the phase difference based on the first distance measurement value.
   (20)

The distance measuring method according to (19), further including an output processing step of generating a third distance measurement value on the basis of the first distance measurement value and the second distance measurement value.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Distance measuring system
11 Light source device
21 Distance measuring device
15 Pattern light
42 Distance measuring sensor
43 Signal processing unit
51 Display device
16 Infrared pulsed laser
20 Control unit
24 Display device
430 Image generation unit
432 Pattern detection unit
434 Determination unit
436 First distance generation unit
437 Phase generation unit
438 Period determination unit
440 Second distance generation unit
442 Output processing unit
444 Second period determination unit

What is claimed is:

1. A distance measuring device comprising:
a distance measuring sensor that receives reflected light that is pattern light emitted from a light source device, reflected by an object, and returned;
a first distance generation unit that generates a first distance measurement value that is a distance to the object on a basis of a position of the pattern light received by the distance measuring sensor;
a phase generation unit that generates, as a phase difference, a time from when the pattern light is emitted to when the pattern light is received as the reflected light; and
a second distance generation unit that generates a second distance measurement value that is a distance to the object, according to: the phase difference; and a repetition period of the phase difference based on the first distance measurement value.

2. The distance measuring device according to claim 1, further comprising an output processing unit that generates a third distance measurement value on a basis of the first distance measurement value and the second distance measurement value.

3. The distance measuring device according to claim 2, wherein
the pattern light is emitted to the object at a predetermined period, and
the distance measuring sensor accumulates charges at the predetermined period and at a plurality of different phases.

4. The distance measuring device according to claim 3, further comprising
a first image generation unit that generates a two-dimensional first image on a basis of at least one of a plurality of detection signals based on the charges accumulated at the plurality of different phases, wherein
the first distance generation unit generates the first distance measurement value by using the first image generated by the first image generation unit.

5. The distance measuring device according to claim 4, wherein the first distance generation unit detects a position of a bright portion of the pattern light, and generates the first distance measurement value by a principle of triangulation on a basis of the position of the bright portion detected.

6. The distance measuring device according to claim 5, wherein
the plurality of different phases is four types of a phase of 0 degrees, a phase of 90 degrees, a phase of 180 degrees, and a phase of 270 degrees, and
the first image generation unit generates the first image on a basis of a combination of the detection signals with the phase of 0 degrees and the phase of 180 degrees or a combination of the detection signals with the phase of 90 degrees and the phase of 270 degrees.

7. The distance measuring device according to claim 6, wherein the first image generation unit generates the first image on a basis of any of the phase of 0 degrees, the phase of 90 degrees, the phase of 180 degrees, and the phase of 270 degrees.

8. The distance measuring device according to claim 7, further comprising
a period determination unit that determines a repetition period of the phases on a basis of the first distance measurement value, wherein
the second distance generation unit generates the second distance measurement value on a basis of the repetition period.

9. The distance measuring device according to claim 8, wherein the output processing unit generates the third distance measurement value by performing weighted averaging on the first distance measurement value and the second distance measurement value by using a first weight value corresponding to the first distance measurement value and a second weight value corresponding to the second distance measurement value.

10. The distance measuring device according to claim 9, further comprising
a determination processing unit that determines whether or not the detection signals in detection of the phase difference are in a saturation state, wherein
the output processing unit generates the third distance measurement value in accordance with determination by the determination processing unit.

11. The distance measuring device according to claim 10, wherein the first distance generation unit generates the first distance measurement value by using the first image generated on the basis of the combination of the detection signals with the phase of 0 degrees and the phase of 180 degrees or the combination of the detection signals with the phase of 90 degrees and the phase of 270 degrees in a case where the determination processing unit determines that the detection signals are in the saturation state.

12. The distance measuring device according to claim 11, wherein the first distance generation unit generates the first distance measurement value by using the first image generated on a basis of the detection signals with the phase of 0 degrees, the phase of 90 degrees, the phase of 180 degrees, and the phase of 270 degrees in a case where the determination processing unit determines that the detection signals are not in the saturation state.

13. The distance measuring device according to claim 12, further comprising a second period determination unit that determines a geometric second repetition period of the pattern light on a basis of the second distance measurement value.

14. The distance measuring device according to claim 13, wherein the first distance generation unit generates the first distance measurement value on a basis of the second repetition period.

15. The distance measuring device according to claim 14, wherein the first distance generation unit generates the first distance measurement value on the basis of the second repetition period in a case where the detection signals are determined to be in the saturation state.

16. A distance measuring system comprising:
a light source device that emits pattern light having two types of luminance of a bright portion and a dark portion; and
a distance measuring device that receives reflected light that is the pattern light reflected by an object and returned, wherein
the distance measuring device includes:
a distance measuring sensor that receives the reflected light that is the pattern light emitted from the light source device, reflected by the object, and returned;
a first distance generation unit that generates a first distance measurement value that is a distance to the object on a basis of a position of the pattern light received by the distance measuring sensor;
a phase generation unit that generates, as a phase difference, a time from when the pattern light is emitted to when the pattern light is received as the reflected light; and
a second distance generation unit that generates a second distance measurement value that is a distance to the object, according to: the phase difference; and a repetition period of the phase difference based on the first distance measurement value.

17. The distance measuring system according to claim 16, wherein the distance measuring device further includes an output processing unit that generates a third distance measurement value on a basis of the first distance measurement value and the second distance measurement value.

18. The distance measuring system according to claim 17, further comprising a display device that displays a distance image on a basis of the third distance measurement value.

19. A distance measuring method using reflected light that is pattern light emitted from a light source device, reflected by an object, and returned, the distance measuring method comprising:
a first distance generation step of generating a first distance measurement value that is a distance to the object on a basis of a position of the pattern light included in the reflected light;
a phase generation step of generating, as a phase difference, a time from when the pattern light is emitted to when the pattern light is received as the reflected light; and
a second distance generation step of generating a second distance measurement value that is a distance to the object, according to: the phase difference; and a repetition period of the phase difference based on the first distance measurement value.

20. The distance measuring method according to claim 19, further comprising an output processing step of generating a third distance measurement value on a basis of the first distance measurement value and the second distance measurement value.
